(19) United States
(12) Patent Application Publication
(10) Pub. No.: US 2026/0177212 A1
(43) Pub. Date: Jun. 25, 2026

(54) LAMP WITH CONFIGURABLE LIGHT QUALITIES

(71) Applicant: FEIT ELECTRIC COMPANY, INC., Pico Rivera, CA (US)

(72) Inventors: James CLARK, Pico Rivera, CA (US); Jose MATA, Pico Rivera, CA (US)

(21) Appl. No.: 19/432,068

(22) Filed: Dec. 23, 2025

Related U.S. Application Data
(60) Provisional application No. 63/738,328, filed on Dec. 23, 2024.

(51) Int. Cl. F21K 9/238

(52) U.S. Cl. CPC F21K 9/238

(57) ABSTRACT

A lamp is provided that includes a base; a lamp envelope; and at least one light engine enclosed within a volume of the lamp defined by the base and the lamp envelope. The base is rotatably secured to the lamp envelope and a selected rotational position of the base with respect to the lamp envelope is configured to select an operating mode of a plurality of operating modes such that when the lamp is operated, the lamp is operated in accordance with the operating mode.

### CROSS-REFERENCE TO RELATED APPLICATION(S)

This application claims priority to U.S. Application No. 63/738,328, filed Dec. 23, 2024, the content of which is incorporated herein by reference in its entirety.

### BACKGROUND

Different lighting applications may be best addressed by light having different light characteristics. For example, the intensity and/or correlated color temperature (CCT) that may be best suited for a kitchen lighting application may be different from the intensity and/or CCT that may be best suited for an office or bedroom lighting application. Conventional lamps are generally only capable of emitting light having a single preset of lighting characteristics. This requires each lighting application within a space to be addressed via a different type of lamp having the light characteristics appropriate for that lighting application. For a home, this may result in needing to stock at least three or four different types of lamps and to keep track of which type of lamp is to be used in each room of the house.

### BRIEF SUMMARY

Example embodiments provide a lamp or light bulb with configurable light characteristics and/or operating modes. In various embodiments, a base of the lamp is rotatably secured to the lamp envelope and a plurality of rotational positions of the base with respect to the lamp envelope are defined. Each of the plurality of rotational positions corresponds to a respective operating mode. An operating mode may define at least one characteristic of light emitted by the lamp during operation, a connected mode (e.g., Wi-Fi, Bluetooth, and/or the like) with which the lamp is configured to communicate with one or more lamps or other smart devices (e.g., smartphone, tablet, other smart lamps, and/or the like), activate/deactivate a motion sensing mode, set a detection range for a motion sensing mode, and/or the like. The lamp is configured to, when operated, operate in accordance with a selected operating mode corresponding to a selected rotational position of the base with respect to the lamp envelope. For example, when the operating mode corresponds to at least one light characteristic, the lamp, when operated, is configured to emit light characterized by the selected at least one light characteristic corresponding to the rotational position of the base with respect to the lamp envelope selected by a user. The rotatable base includes a stop that allows for securely tightening the lamp base into a corresponding threaded socket (allowing a good electrical connection between the base and the socket). Once the lamp is secured in the socket, a second stop is provided to allow the un-tightening of the lamp from the socket (e.g., for changing out a spent lamp.) In various embodiments, the at least one light characteristic is a correlated color temperature (CCT), luminous flux, beam profile, beam direction, color rendering index (CRI), or a combination of two or more thereof.

According to an aspect of the present disclosure, a lamp configured to operate in a selected operating mode is provided. In an example embodiment, the lamp includes a base configured to be installed into a socket, a lamp envelope, and at least one light engine enclosed within a lamp volume defined by the base and the lamp envelope. The base is rotatably secured to the lamp envelope. A selected rotational position of the base with respect to the lamp envelope is configured to select an operating mode of the lamp such that, when the lamp is operated, the lamp operates in accordance with the selected operating mode.

According to another aspect, a lamp configured to emit light of a configurable CCT is provided. In an example embodiment, the lamp includes a base configured to be installed into a socket, a lamp envelope; and at least one light engine enclosed within a volume of the lamp defined by the base and the lamp envelope. The base is rotatably secured to the lamp envelope and a selected rotational position of the base with respect to the lamp envelope is configured to indicate a selected CCT such that when the lamp is operated, the lamp emits light characterized by the selected CCT.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a partial cutaway perspective view of an example lamp in accordance with an example embodiment;

FIG. 2A is a perspective view of an example lamp in accordance with an example embodiment;

FIG. 2B provides an illustration of portion of an example lamp and schematically illustrates selection of a rotatable position thereof, in accordance with certain embodiments;

FIG. 3 is a front view of an example optics component in accordance with an example embodiment;

FIG. 4 provides a flowchart illustrating process and procedures of installing and operating lamp with configurable light characteristics in accordance with certain embodiments;

FIG. 5A provides an exploded perspective view of a coupling portion of an example lamp, in accordance with an example embodiment;

FIG. 5B provides an exploded perspective view of the coupling portion illustrated in FIG. 5A from an opposite direction;

FIG. 5C provides a perspective view of the coupling portion of an example lamp, in accordance with an example embodiment;

FIG. 5D provides a perspective view of a portion of an example lamp, in accordance with an example embodiment;

FIG. 6 provides a perspective view of an example driver ring, in accordance with an example embodiment; and

FIG. 7 provides a flowchart illustrating various processes and/or procedures for installing a lamp, in accordance with an example embodiment.

### DETAILED DESCRIPTION OF VARIOUS EMBODIMENTS

Various embodiments now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Example embodiments provide lamps or light bulbs with configurable operating modes. An operating mode may define at least one light characteristic of light emitted by the lamp during operation, a connected mode (e.g., Wi-Fi, Bluetooth, and/or the like) with which the lamp is configured to communicate with one or more other smart devices (e.g., smartphone, tablet, other smart lamps, and/or the like), activate/deactivate a motion sensing mode, set a detection range for a motion sensing mode, and/or the like. In various embodiments, a base of the lamp is rotatably secured to the lamp envelope and a plurality of rotational positions of the base with respect to the lamp envelope are defined. Each of the plurality of rotational positions corresponds to a respective operating mode. The lamp is configured to, when operated, operate in accordance with the operating mode corresponding to the rotational position of the base with respect to the lamp envelope selected by a user. For example, certain embodiments provide lamps or light bulbs with configurable light characteristics. Some example light characteristics that may be configured in various embodiments include correlated color temperature (CCT), color, luminous flux, beam profile, beam direction, beam dispersion, color rendering index (CRI), or a combination of two or more thereof.

For example, a user may install the lamp within a socket. For example, installing the lamp in a socket may include rotating the lamp in a clockwise direction with respect to the socket such that threading of the base of the lamp engages with threading of the socket. Once the lamp is securely installed within the socket, the user may rotate the lamp envelope counter-clockwise with respect to the base and the socket to select one of a plurality of rotational positions. The selected rotational position corresponds to a selected operating mode of the lamp. The user may then operate the lamp by turning on a light switch corresponding to the socket into which the lamp is installed or turning on a lighting device that includes the socket into which the lamp is installed. When operating, the lamp operates in accordance with the selected operating mode. For example, when the operating mode corresponding to the rotational position of the base with respect to the lamp envelope corresponds to at least one light characteristic such that, when operating, the lamp emits light characterized by the selected at least one light characteristic.

### Example Lamp

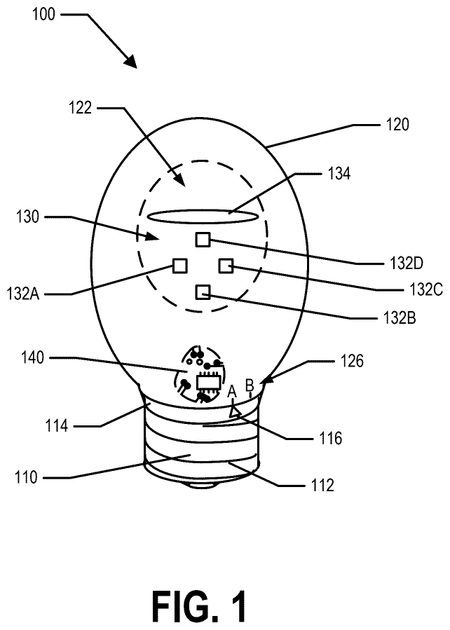

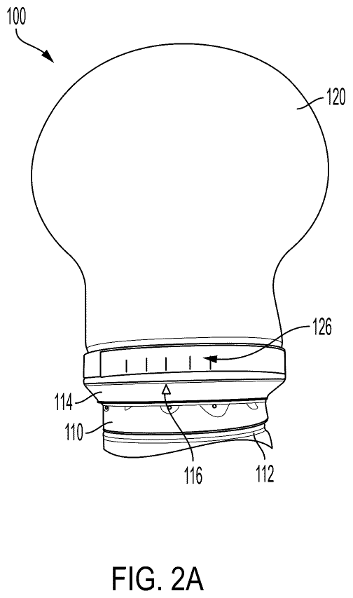

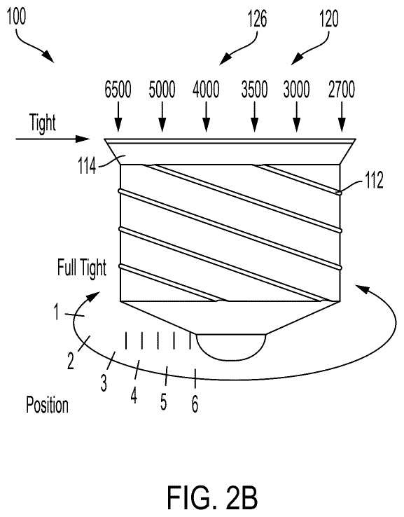

FIG. 1 provides a partial cutaway perspective view of an example lamp 100 in accordance with an example embodiment. FIG. 2 provides a perspective view of an example lamp 100. As shown in FIGS. 1,2A, and 2B, the lamp 100 includes a base 110 and a lamp envelope 120. In various embodiments, the lamp 100 comprises one or more light engines. The one or more light engines may be light emitting diodes (LEDs), filaments, fluorescent tubes, and/or the like.

The base 110 includes an engagement portion 112 configured for be installed into a socket. For example, the engagement portion 112 may be configured to mechanically secure the lamp 100 into a socket and electrically connect the lamp 100 to the socket. In various embodiments, the engagement portion 112 may be threaded. For example, the engagement portion 112 may comprise threads configured to mate with corresponding threads of a socket. In various embodiments, the base 110 may be an E10, E11, E12, E14, D17, E26, E39, G4, GU4, G5, GU5.3, GX5.3, GY5.3, G6.35, GY6.35, GZ6.35, GU6.5, GY8, G8.5, G9, G9.5, GZ9.5, GU10, G12, GU24, or other standard base size and/or configuration.

The base 110 further includes an envelope coupling portion 114. In various embodiments, the envelope coupling portion 114 is configured to couple the base 110 to the lamp envelope 120 such that the base 110 and the lamp envelope 120 are rotationally secured to one another. In various embodiments, the base 110 and the lamp envelope 120 are rotationally secured to one another such that the base 110 and the lamp envelope 120 may be rotated with respect to one another over a preset or predefined angular range. For example, a plurality of rotational positions of the base 110 with respect to the lamp envelope 120 may be defined within the preset or predefined angular range. In various embodiments, the preset or predefined angular range is at most 360 degrees. In some embodiments, the preset or predefined angular range is at most 180 degrees. For example, when the lamp 100 is installed into a socket by rotating the lamp 100 clockwise with respect to the circuit, the lamp envelope 120 may be rotate counter-clockwise with respect to the base 110 through the preset or predefined angular range to select a rotational position of the plurality of rotational positions. However, once the lamp envelope 120 was rotated counter-clockwise with respect to the base 110 through the preset or predefined angular range, the base 110 is engaged and further rotation of the lamp envelope 120 also causes rotation of the base 110 with respect to the socket so as to remove or unscrew the lamp from the socket.

In various embodiments, the envelope coupling portion 114 includes a selection indicator 116 configured to provide visual indication to a user regarding the selected rotational position. For example, the lamp envelope 120 may include position indicators 126 configured to indicate respective rotational positions of the plurality of rotational positions. The position indicator 126 aligned with the selection indicator 116 is the currently selected rotational position.

In various embodiments, the lamp envelope 120 is an at least semi-transparent or translucent globe, bulb, or enclosing element. For example, the lamp envelope 120 may be formed of clear or frosted glass or a semi-transparent, transparent, translucent, clear, and/or frosted plastic.

In various embodiments, the lamp envelope 120, with the base 110, encloses a lamp volume 122. For example, the lamp envelope 120 and the base 110 prevent user access to the lamp volume 122. At least one light engine 130 is mounted within the lamp volume 122. In various embodiments, a control unit 140 is mounted within the lamp volume 122 and configured to control operation of the at least one light engine 130 based at least in part on the selected rotational position of the base 110 with respect to the lamp envelope 120. In certain embodiments, the control unit 140 is configured to determine the selected rotational position of the base 110 with respect to the lamp envelope 120 and control operation of the lamp 100 such that the lamp 100 emits light in accordance with the at least one light characteristic corresponding to the selected rotational position of the base 110 with respect to the lamp envelope 120.

In various embodiments, the at least one light engine 130 comprises one or more light emitting diodes (LED) packages 132 (e.g., 132A-D). In example embodiments, an LED package 132 comprises one or more LED chips, electrical contacts, and optionally phosphor (e.g., to cause the LED package to emit white light). The LED package 132 may further comprise encapsulant to protect the one or more LED chips, wire bonds, and the phosphor. In an example embodiment, the LED packages 132 may comprise one or more alternate current (AC) driven LEDs. In some embodiments, the LED package 132 may further comprise one or more optical elements configured to control one or more CCT, CRI, beam direction, beam profile, beam dispersion, color (“white”, red, green, blue, purple, orange, etc.), and/or the like of the light emitted by the LED package 132.

In example embodiments, the one or more LED packages 132 may comprise a plurality LED packages 132. In example embodiments, the plurality of LED packages may comprise at least one first LED package 132A and at least one second LED package 132B. The first LED package 132A may be configured to emit light at a first CCT and the second LED package 132B may be configured to emit light at a second CCT. The second CCT may be different from the first CCT. For example, the first CCT may be 3000K or 2700K and the second CCT may be 5000K. In example embodiments, the plurality of LED packages 132 may further comprise a third and/or fourth LED package 132C, 132D configured to emit light at a third and/or fourth CCT, respectively, wherein the third and/or fourth CCT are different from the first and second CCTs. For example, in various embodiments, one or more of the LED packages 132 may be configured to emit light of at least one of 2700K, 3000K, 3500K, 4000K, 5000K, 5700K, 6000K, 7000K, 7500K and/or other CCTs, as appropriate for the application.

For example, the lamp 100 may be configured to emit light of the first CCT when a first rotational position is selected, emit light of a CCT between the first CCT and a second CCT when a second rotational position is selected, and emit light of a second CCT when a third rotation position is selected. When the first rotational position is selected, the control unit 140 may control operation of the at least one light engine 130 such that the LED packages 132A configured to emit light of the first CCT are operated to emit light (but the LED packages 132B configured to emit light of the second CCT are not operated). The lamp 100 therefore emits light characterized by the first CCT. When the third rotational position is selected, the control unit 140 may control operation of the at least one light engine such that the LED packages 132B configured to emit light of the second CCT are operated to emit light (but the LED packages 132A configured to emit light of the first CCT are not operated). The lamp 100 therefore emits light characterized by the second CCT. When the second rotational position is selected, the control unit 140 operates the LED packages 132A and the LED packages 132B such that when the light emitted by the LED packages 132A and the light emitted by the LED packages 132B are mixed (e.g., by an optics component 134 and/or the like), the lamp 100 emits light of the CCT that is between the first CCT and the second CCT. As should be understood, the at least one light engine 130 may include LED packages 132C configured to emit light of a third CCT and/or LED packages 132D configured to emit light of a fourth CCT and the lamp 100 may be configured to emit light of the first CCT, second CCT, third CCT, fourth CCT, one or more CCTs between the first CCT and the second CCT, one or more CCTs between the second CCT and the third CCT, and/or one or more CCTs between the third CCT and the fourth CCT, where the second CCT is greater than the first CCT, the third CCT is greater than the second CCT, and the fourth CCT is greater than the third CCT. In an example embodiment, a selected rotation position may correspond to a selected CCT and at least one additional light characteristic (e.g., at least one of luminous flux, beam profile, beam direction, beam dispersion, CRI, or a combination of two or more thereof)

In example embodiments, the one or more LED packages 132 may be in electrical communication with a control unit 140 such that the one or more LED packages 132 may be operated by the control unit 140. In various embodiments, the control unit 140 is configured to control operation of the light engine 130 such that the lamp 100 emits light having light characteristics corresponding to the selected rotational position of the base 110 with respect to the lamp envelope 120 by controlling operation of the one or more LED packages 132.

In example embodiments, the control unit 140 may be configured to control how the one or more LED packages are operated and/or to operate subsets of the one or more LED packages 132 at a particular given moment in time based at least in part on the selected rotational position of the base 110 with respect to the lamp envelope 120. For example, the control unit 140 may provide a controlled electrical current to at least one of the LED packages 132. For example, the control unit 140 may be configured to only operate first LED packages 132A to cause the lamp 100 to emit light of the first CCT (e.g., when the selected rotational position is the first position corresponding to the first CCT). In another example, the control unit 140 may be configured to only operate second LED packages 132B to cause the lamp 100 to emit light of the second CCT (e.g., when the selected rotational position is the third position corresponding to the second CCT). In another example, the control unit 140 may be configured to operate one or more (e.g., half) of the first LED packages 132A and one or more (e.g., half) of the second LED packages 132B to cause the lamp 100 to emit light of a CCT that is between the first CCT and the second CCT (e.g., when the selected rotational position is a second position corresponding to the CCT between the first CCT and the second CCT). In example embodiments, the first CCT, second CCT, and third CCT may be different from one another. For example, the first CCT may be 3000K, the second CCT may be 5000K, and the third CCT may be 4000K. In some embodiments, the lamp 100 may comprise LED packages 132 configured to emit light at more than two distinct CCTs (e.g., three, four, or more distinct CCTs).

In example embodiments, the one or more LED packages 132 may be configured to provide light that varies in luminous flux (e.g., brightness/intensity), CCT, CRI, and/or the like based on the current provided to the one or more LED packages 132 by the control unit 140. For example, the control unit 140 may provide a particular current to an LED package 132 to cause the LED package 132 to provide light having particular light characteristics.

In example embodiments, the LED packages 132 may comprise one or more LED packages 132 that are configured to emit light other than “white” light. For example, the LED packages 132 may comprise one or more LED packages 132 configured to emit a red or amber light that may be operated to increase the CRI of the light emitted by the lamp 100.

In example embodiments, the control unit 140 may be configured to provide a controlled electrical current to the one or more LED packages 132 during operation of the lamp 100. In various embodiments, the control unit 140 comprises driver circuitry configured to condition an electrical current provided to selected one LED packages of the one or more LED packages. For example, the driver circuity may comprise a circuit portion configured to convert AC voltage into DC voltage. In some embodiments, the driver circuitry may comprise a circuit portion configured to control an amount of the current supplied to or flowing through the one or more LED packages 132. In certain embodiments, the driver circuitry may comprise a circuit portion configured to control the luminous flux (e.g., brightness/intensity) of the lamp 100. In various embodiments, additional circuit components may be present in the driver circuitry of the control unit 140. Similarly, in various embodiments, all or some of the circuit portions mentioned here may not be present in the driver circuitry of the control unit 140. In some embodiments, circuit portions listed herein as separate circuit portions may be combined into one circuit portion. As should be appreciated, a variety of driver circuitry configurations are generally known and understood in the art and any of such may be employed in various embodiments as suitable for the intended application, without departing from the scope of the present invention.

As will be understood, the control unit 140 may be embodied in a number of different ways. In various embodiments, the control unit 140 is configured to operate the lamp 100 in accordance with an operating mode corresponding to the selected rotational position of the base 110 with respect to the lamp envelope 120. For example, in various embodiments, the control unit 140 comprises one or more circuit components that are selectively activated during operation of the lamp 100 based on selected rotational position of the base 110 with respect to lamp envelope 120. For example, in certain embodiments, when the base 110 is in a first rotational position with respect to the lamp envelope 120, a first set of circuit components are activated during operation of the lamp 100 to control, for example, at least one light characteristic of light emitted by the lamp 100 and when the base 110 is in a second rotational position with respect to the lamp envelope 120, a second set of circuit components are activated during operation of the lamp 100 to control the at least one light characteristic of light emitted by the lamp 100. In another example, embodiment, the control unit 140 may include or be in communication with one or more communications interfaces configured to communicate via radio communications (e.g., Wi-Fi, Bluetooth, and/or the like) and the control unit 140 may be configured to cause operation of the one or more communication interfaces to enable communication via a protocol (e.g., Wi-Fi, Bluetooth, and/or the like) corresponding to the selected rotational position of the base 110 with respect to the lamp envelope 120.

In certain embodiments, the control unit 140 may be embodied as one or more complex programmable logic devices (CPLDs), microprocessors, multi-core processors, co-processing entities, application-specific instruction-set processors (ASIPs), microcontrollers, and/or controllers. Further, the control unit 140 may be embodied as one or more other processing devices or circuitry. The term circuitry may refer to an entirely hardware embodiment or a combination of hardware and computer program products. Thus, the control unit 140 may be embodied as integrated circuits, application specific integrated circuits (ASICs), field programmable gate arrays (FPGAs), programmable logic arrays (PLAs), hardware accelerators, other circuitry, and/or the like. As will therefore be understood, the control unit 140 may be configured for a particular use or configured to execute instructions stored in volatile or non-volatile media or otherwise accessible to the control unit 140. As such, whether configured by hardware or computer program products, or by a combination thereof, the control unit 140 is capable of performing steps or operations according to embodiments of the present disclosure when configured accordingly.

In various embodiments, the control unit 140 is configured to drive one or more LED packages 132 such that the LED packages provide light characterized by the at least one light characteristic corresponding to the selected rotational position of the base 110 with respect to the lamp envelope 120. For example, which LED packages 132 of the one or more LED packages 132 the control unit 140 provides electrical current to and/or the magnitude of the provided electrical current may be controlled by the control unit 140 based on the selected rotational position of the base 110 with respect to the lamp envelope 120. In other words, in various embodiments, the control unit 140 is configured to control operation of the light engine 130 such that the lamp 100 emits light having light characteristics corresponding to the selected rotational position of the base 110 with respect to the lamp envelope 120 by controlling operation of the one or more LED packages 132.

In certain embodiments, the at least one light engine 130 includes at least one optics component 134. For example, the at least one optics component 134 may be configured to condition at least some of the light emitted by the one or more LED packages 132. In some embodiments, the optics component 134 is configured to mix light emitted by various LED packages 132 of the one or more LED packages 132, control a beam profile of light emitted by the lamp 100, control a beam direction of the light emitted by the lamp 100, control the CCT of light emitted by the lamp 100, and/or control the CRI of light emitted by the lamp 100. For example, the optics component may include one or more optics elements such as lenses, gratings, dispersion elements, reflective elements, color filters, fluorescent elements, and/or the like. In an example embodiment, the optics component 134 is a static optics component 134 such that the effect or conditioning of the light emitted by the lamp 100 is substantially the same regardless of the selected rotational position of the base 110 with respect to the lamp envelope 120. In some embodiments, the optics component 134 is a dynamic optics component 134 such that the effect or conditioning of the light emitted by the lamp 100 is different for at least two or the rotational positions of the base 110 with respect to the lamp envelope 120.

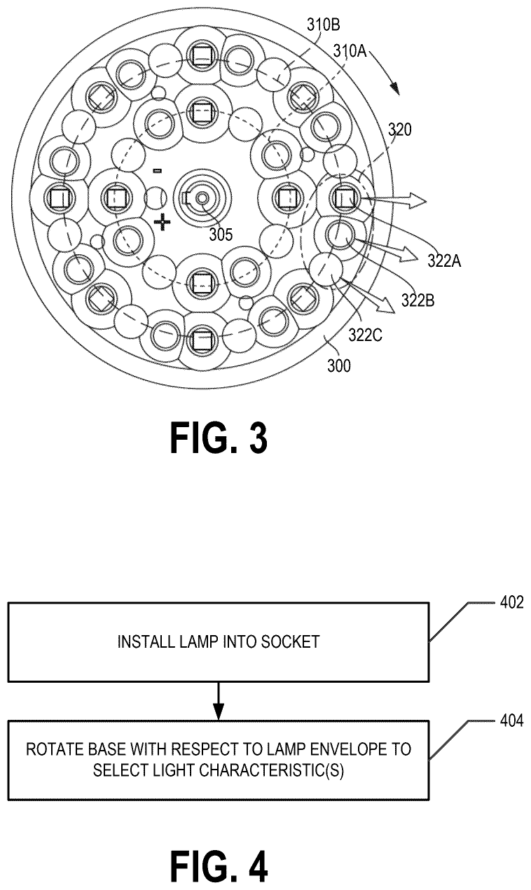

FIG. 3 provides a top view of one example dynamic optics component 300 that may be used as the optics component 134 of an example lamp 100. The dynamic optics component 300 includes a plurality of sets 320 of optical elements 322 (e.g., 322A, 322B, 322C). Each optical element 322 of a set 320 of optical elements is configured to condition light incident thereon in a different manner. For example, an optical element 322 of a set 320 of optical elements may be a lens configured to control a focal point, beam waist, or convergence/divergence of light incident thereon. In an example embodiment, an optical element 322 of a set 320 of optical elements may be grating or dispersion element configured to mix and/or disperse light incident thereon. In another example, an optical element 322 of a set 320 of optical elements may be a reflective element or other element configured to control a beam direction of light incident thereon. In an example, an optical element 322 of a set 320 of optical elements may be a color filter configured to affect a color of light incident thereon. In an example embodiment, an optical element 322 of a set 320 of optical elements may be a fluorescent element configured to emit fluorescence of a particular CCT, CRI, color, and/or the like when light having a particular characteristic (e.g., wavelength, intensity, and/or the like) is incident thereon.

In the illustrated embodiment, the sets 320 of optical elements 322 are arranged in a first loop arrangement 310A and a second loop arrangement 310B. In various embodiments, the arrangement of the sets 320 of optical elements 322 are arranged such that for each LED package 132 of the one or more LED packages, an optical element 322 configured to condition a light emitted by the corresponding LED package 132 to be characterized by the at least one light characteristic is aligned with the LED package 132.

In various embodiments, the optics component 300 is configured to rotate about a central rotation point 305 of the optics component 300. For example, the optics component 300 may be rotated (about the central rotation point 305) responsive to the rotation of the base 110 with respect to the lamp envelope 120 such that optical elements 322 configured to condition light emitted by the LED packages 132 to be characterized by the at least one light characteristic is aligned with the LED packages 132. In an example embodiment, the rotation of the optics component 300 is control by the control unit 140. In another example embodiment, the rotation of the optics component 300 is mechanically caused by rotation of the base 110 with respect to the lamp envelope 120. For example, rotation of the base 110 with respect to the lamp envelope 120 causes mechanical movement of the one or more optics components to align at least one optical element of the one or more optics components corresponding to the selected at least one light characteristic to be aligned with one or more LEDs of the at least one light engine 130.

FIG. 4 provides a flowchart illustrating processes, procedures, operations, and/or the like of installing a lamp 100 in a socket, according to certain embodiments. In various embodiments, the socket is a standard socket of a lighting fixture, lighting device, luminaire, and/or the like. Starting at step 402, a user installs the lamp 100 into a socket. For example, the user may rotate the lamp 100 with respect to the socket in a clockwise direction until the lamp 100 is mechanically and electrically secured into the socket.

At step 404, the user rotates the lamp envelope 120 counter-clockwise with respect to the base 110 (which is secured within the socket) to a selected rotation position of the base 110 with respect to the lamp envelope 120. The selected rotation position of the base 110 with respect to the lamp envelope 120 corresponds to a selected operating mode. When the lamp 100 is operated, the lamp is configured to operate in accordance with the selected operating mode. An operating mode may define at least one light characteristic of light emitted by the lamp during operation, a connected mode (e.g., Wi-Fi, Bluetooth, and/or the like) with which the lamp is configured to communicate with one or more other smart devices (e.g., smartphone, tablet, other smart lamps, and/or the like), activate/deactivate a motion sensing mode, set a detection range for a motion sensing mode, and/or the like. For example, when the selected operating mode corresponds to at least one light characteristic, the lamp 100 is configured, when operated, to emit light characterized by the at least one light characteristic corresponding to the selected rotation position of the base 110 with respect to the lamp envelope 120.

In various embodiments, the user may use visible position indicators 126 to determine the rotational position of the base 110 with respect to the lamp envelope 120. In another example embodiment, the lamp 100 may be configured to make an audible noise (e.g., click and/or the like) as the user rotates the lamp envelope 120 through the preset and/or predefined rotational positions of the base 110 with respect to the lamp envelope 120. For example, when the user hears two clicks while rotating the lamp envelope 120 counter-clockwise with respect to the base 110 (which is secured within a socket) the user knows the base 110 is in a second rotational position with respect to the lamp envelope 120. In certain embodiments, the lamp 100 may be configured to provide haptic feedback as the user rotates the lamp envelope 120 through the preset and/or predefined rotational positions of the base 110 with respect to the lamp envelope 120. For example, when the user feels two clicks while rotating the lamp envelope 120 counter-clockwise with respect to the base 110 (which is secured within a socket) the user knows the base 110 is in a second rotational position with respect to the lamp envelope 120.

The user may then operate the lamp 100 by providing electrical current to the socket. For example, the user may turn on a light switch in electrical communication with the socket, turn on the lighting device or lighting fixture including the socket, and/or the like. In response to the socket providing electrical current to the lamp 100, the lamp operates in accordance with the operating mode corresponding to the selected rotational position of the base 110 with respect to the lamp envelope 120. For example, in certain embodiments, the lamp 100 emits light characterized by at least one of a selected CCT, color, luminous flux, beam profile, beam direction, beam dispersion, CRI, or a combination of two or more thereof.

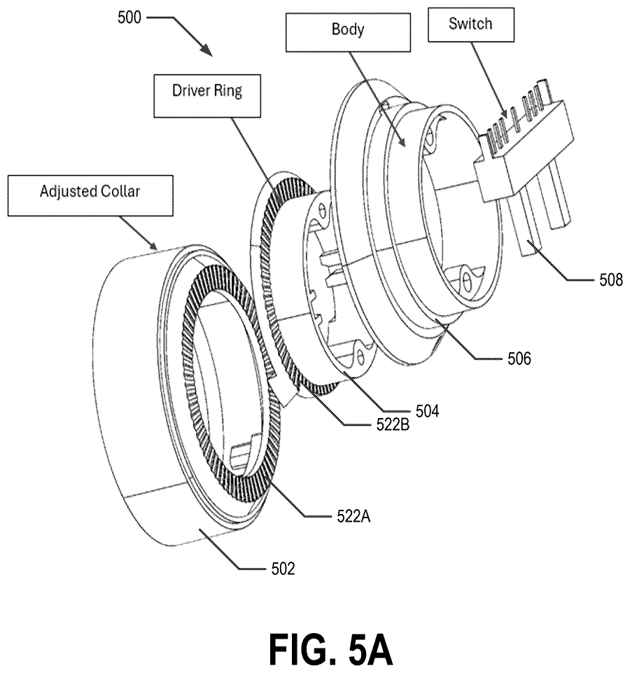

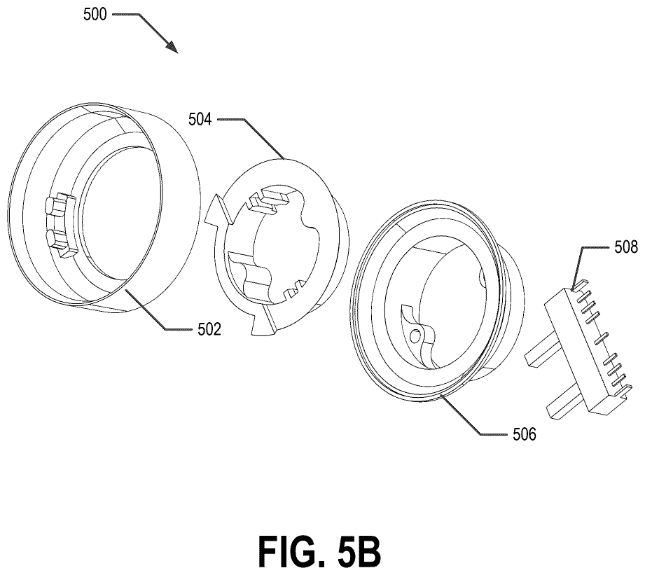

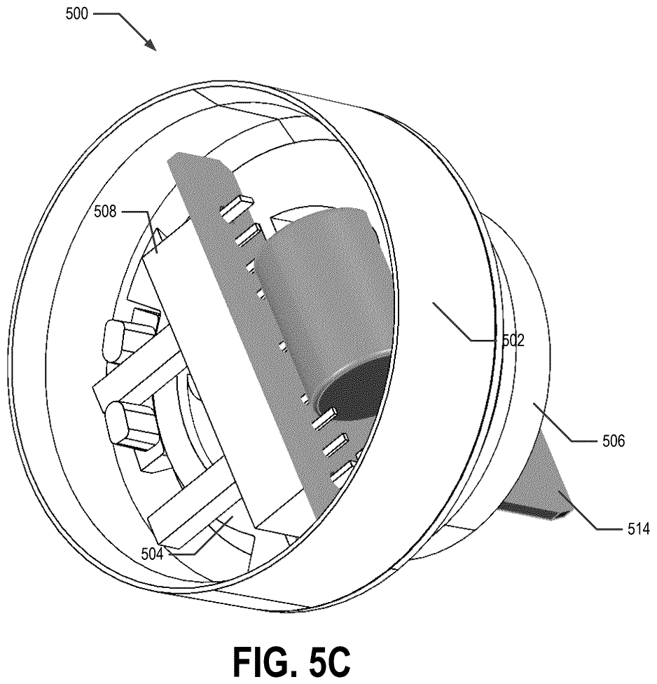

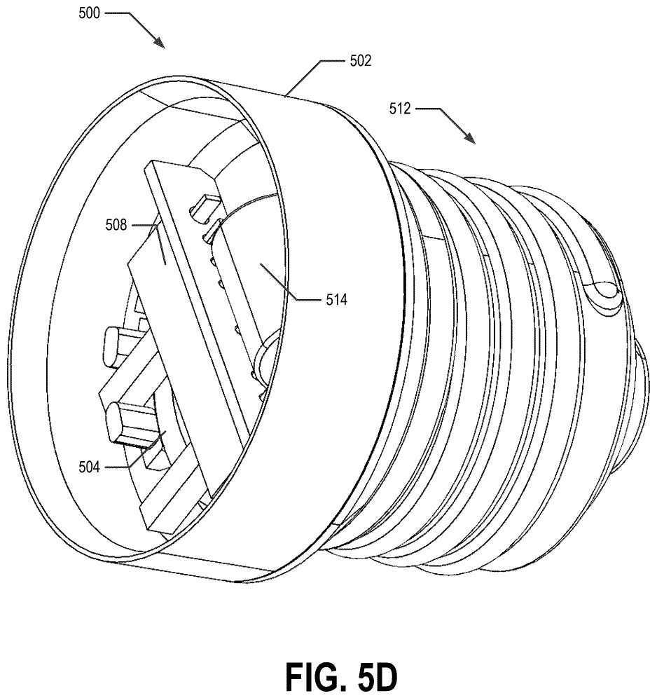

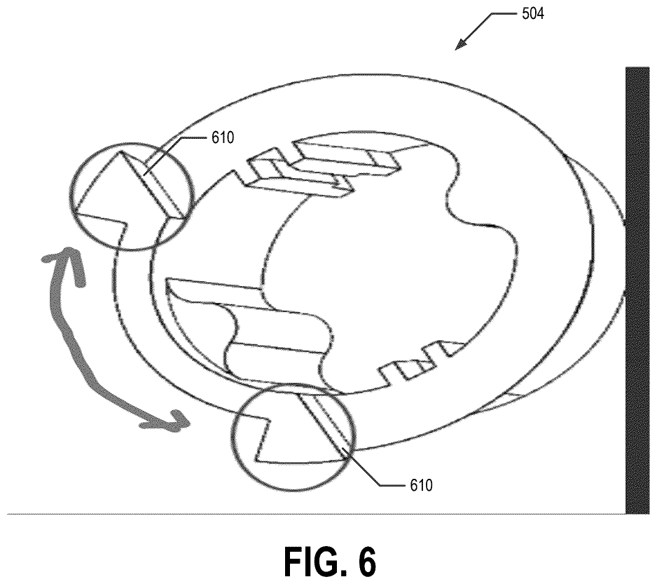

FIGS. 5A-5D and 6 provide various views of at least a portion of an example lamp 100. For example, FIGS. 5A-5D illustrate various views of a coupling portion 500 of the example lamp. As shown in FIG. 5D, the coupling portion 500 is coupled to the threaded portion 512 of the base and to the lamp envelope.

The coupling portion 500 may include an adjustable collar 502 configured to engage a driver ring 504. The coupling portion 500 may further include a switch 508 and a body 506. The body 506 may act at least in part as a housing with respect to the switch 508. Rotation of the adjustable collar 502 causes rotation of the driver ring 504, in some embodiments. In some embodiments, a user may directly rotate the driver ring 504. Rotation of the driver ring 504 causes adjustment of the switch 508 such that a desired portion of the switch is in electrical communication with the contact 514. For example, in some embodiments, the portion of the switch 508 that is in electrical communication with the contact 514 controls the characteristic of light emitted by the lamp 100 during operation thereof.

In the illustrated embodiment, the adjustable collar 502 and the driver ring include ridges 522A, 522B. In some embodiments, the ridges 522A, 522B are configured to engage with one another. The functionality of the ridges 522A, 522B on the adjustable collar 502 and the driver ring 504 are for tension, so that there is a resistance on that prevents undesired rotation of the lamp envelope with respect to the base. The driver ring 504 may slide in conjunction with the adjustable collar 502. The body 506 is configured to hold the driver ring 504 in an engaged configuration with the adjustable collar 502. The adjustable collar 502 is secured to the lamp envelope by glue or some other adhesive. The body 506 may be secured to the threaded shell of the base.

As shown in FIG. 6, the driver ring 504 may include stops 610 that control the relative rotation of the base 110 with respect to the lamp envelop 120. For example, the relative rotation of the base 110 with respect to the lamp envelope 120 may only occur within the designated arc (e.g., the illustrated double-arrowed arc) as defined by the stops 610. This enables a user to rotate the threaded portion of the lamp into a threaded socket until the threads of the lamp are fully engaged, and then allows a user to rotate the lamp envelope with respect to the base to select the characteristic (e.g., via the selected rotational position). The stops 610 further enable disengagement of the lamp from the socket via rotation of the base with respect to the socket.

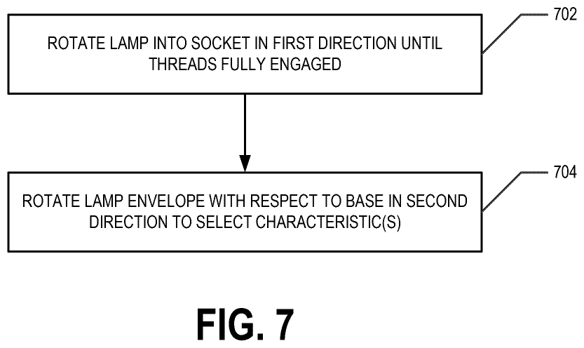

FIG. 7 provides a flowchart illustrating various processes and/or procedures for installing a lamp 100, in accordance with an example embodiment. At block 702, the lamp is rotated into engagement with the socket. For example, a user may rotate the lamp (e.g., the base of the lamp) into the socket in a first direction until the threads of the base are fully engaged with the mating threads of the socket.

At block 704, the characteristics of the light emitted from the lamp is selected by selecting a rotational position of the lamp envelope with respect to the base. In various embodiments, the rotational position of the lamp envelope with respect to the base is selected by rotating the lamp envelop with respect to the base in a second direction. The first direction and the second direction are opposites. For example, the first direction may be clockwise and the second direction may be counter-clockwise. In other words, the lamp may be screwed into a socket to make a good electrical connection between the lamp and the socket and then adjusted to the selected rotational position without loosening the bulb with respect to the socket.

### CONCLUSION

Many modifications and other embodiments of the disclosure set forth herein will come to mind to one skilled in the art to which the disclosure pertains having the benefit of the teachings presented in the foregoing descriptions and the associated drawings. Therefore, it is to be understood that the disclosure is not to be limited to the specific embodiments disclosed and appended claims. Although specific terms are employed herein, they are used in a generic and descriptive sense only and not for purposes of limitation.

1. A lamp comprising:
a base;
a lamp envelope; and
at least one light engine enclosed within a volume of the lamp defined by the base and the lamp envelope,
wherein the base is rotatably secured to the lamp envelope and a selected rotational position of the base with respect to the lamp envelope is configured to select an operating mode such that when the lamp is operated, the lamp operates in accordance with the operating mode.

2. The lamp of FIG. 1, wherein the selected rotational position is selectable from at least three selectable positions and each of the at least three selectable positions corresponds to a respective characteristic value.

3. The lamp of claim 1, wherein the operating mode defines one or more of:
at least one light characteristic of light emitted by the lamp during operation,
a connected mode with which the lamp is configured to communicate with one or more other smart devices,
whether a motion sensing mode is activated or deactivated, or
set a detection range for the motion sensing mode.

4. The lamp of claim 3, wherein the at least one light characteristic is one or more of correlated color temperature (CCT), color, luminous flux, beam profile, beam direction, beam dispersion, color, or color rendering index (CRI).

5. The lamp of claim 1, wherein at least one of the base or the lamp envelope defines a plurality of rotational positions with each rotational position of the plurality of rotational positions corresponding to a respective operating mode of a plurality of operating modes, the selected rotational position being one of the plurality of rotational positions.

6. The lamp of claim 1, wherein the at least one light engine comprises one or more light emitting diode (LED) packages.

7. The lamp of claim 6, wherein the one or more LED packages are operable to emit light of at least one of a configurable correlated color temperature (CCT), a configurable luminous flux, a configurable color rendering index (CRI), or a particular color.

8. The lamp of claim 1, wherein the at least one light engine comprises one or more optics components configured to condition light emitted by the lamp.

9. The lamp of claim 8, wherein the one or more optics components are configured to control at least one of a beam profile, beam direction, beam dispersion, correlated color temperature (CCT), color, or a configurable color rendering index (CRI) of light emitted by the lamp.

10. The lamp of claim 8, wherein rotation of the base with respect to the lamp envelope causes mechanical movement of the one or more optics components to align at least one optical element of the one or more optics components corresponding to the operating mode to be aligned with one or more light emitting diode (LED) packages of the at least one light engine.

11. The lamp of claim 1, further comprising a control unit configured to determine the selected rotational position of the base with respect to the lamp and control operation of the lamp such that the lamp is operated in accordance with the operating mode.

12. The lamp of claim 11, wherein the control unit is configured to control operation of the lamp such that the lamp emits light in accordance with the operating mode by controlling flow of electrical current to the at least one light engine.

13. A lamp comprising:
a base;
a lamp envelope; and
at least one light engine enclosed within a volume of the lamp defined by the base and the lamp envelope,
wherein, the base is rotatably secured to the lamp envelope and a selected rotational position of the base with respect to the lamp envelope is configured to indicate a selected correlated color temperature (CCT) such that when the lamp is operated, the lamp emits light characterized by the selected CCT.

14. The lamp of claim 13, wherein at least one of the base or the lamp envelope defines a plurality of rotational positions with each rotational position of the plurality of rotational positions corresponding to a respective CCT.

15. The lamp of claim 14, wherein at least one of the plurality of rotational positions corresponds to the respective CCT and at least one additional light characteristic.

16. The lamp of claim 15, wherein the at last one additional light characteristic is at least one of luminous flux, beam profile, beam direction, beam dispersion, or color rendering index (CRI).

17. The lamp of claim 13, wherein the at least one light engine comprises one or more light emitting diode (LED) packages.

18. The lamp of claim 17, wherein the one or more LED packages are operable to emit light of a configurable CCT, the configurable CCT ranging from a coolest selectable CCT of a plurality of selectable CCTs to a warmest selectable CCT of the plurality of selectable CCTs, each selectable CCT of the plurality of selectable CCTs corresponding to a respective rotational position of a plurality of rotational positions defined by at least one of the base or the lamp envelope.

19. The lamp of claim 13, further comprising a control unit configured to determine the selected rotational position of the base with respect to the lamp envelope and control operation of the lamp such that the lamp emits light characterized by the selected CCT corresponding to the selected rotational position of the base with respect to the lamp envelope.

20. The lamp of claim 19, wherein the control unit is configured to control operation of the lamp such that the lamp emits light in characterized by the selected CCT by controlling flow of electrical current to at least one light emitting diode (LED) package of the at least one light engine.
